(19) United States
(12) Patent Application Publication
(10) Pub. No.: US 2025/0362790 A1
(43) Pub. Date: Nov. 27, 2025

(54) SYSTEM AND METHOD FOR CONTEXT-AWARE VIRTUAL ASSISTANT

(71) Applicant: Wells Fargo Bank, N.A., San Francisco, CA (US)

(72) Inventor: Sundarapandian Sethuramachandran, Chandler, AZ (US)

(21) Appl. No.: 19/213,045

(22) Filed: May 20, 2025

Related U.S. Application Data
(60) Provisional application No. 63/650,151, filed on May 21, 2024.

(51) Int. Cl. G06F 3/04845; G06F 3/04883; G06Q 40/02

(52) U.S. Cl. CPC G06F 3/04845; G06F 3/04883; G06Q 40/02

(57) ABSTRACT

Systems and methods are provided. In one example, a method includes presenting, via a graphical user interface (GUI), a GUI screen on a display of a computing device, wherein the GUI screen is configured to present textual information, and capturing an annotation made by a user on a portion of the GUI screen, wherein the annotation comprises a textual annotation, a drawing annotation, or a combination thereof. The method also includes deriving a context for the annotation based at least on the portion of the GUI screen having the annotation, wherein the context comprises a subset of the presented textual information, and creating a data store query based on the context and on the annotation. The method further includes querying, via the data store query, a data store, and presenting, via the GUI, a result based on the querying of the data store.

### CROSS-REFERENCE TO RELATED APPLICATION

This patent application claims the benefit of U.S. Provisional Patent Application No. 63/650,151, filed May 21, 2024, which is incorporated by reference herein in its entirety.

### TECHNICAL FIELD

The present disclosure generally relates to virtual assistants, and more specifically to context-aware virtual assistants.

### BACKGROUND

Virtual assistants, such as chatbots, provide for domain advice. For example, a financial chatbot provides for advice on transferring funds, opening a new account, making a payment on a loan, and so on. Virtual assistants are included in application software, such as online applications.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 illustrates a block diagram depicting a context-aware virtual assistant system (CAVAS), in accordance with certain examples.

FIG. 2 illustrates a block diagram of an image capture component wrapper communicatively coupled to a natural language processing (NLP) pipeline, in accordance with certain examples.

FIG. 3 illustrates a flowchart of a process suitable for using the context-aware virtual assistant system of FIG. 1 to capture and to contextually process multi-model annotations, in accordance with certain examples.

FIG. 4 illustrates screenshots of various screens, such as mobile banking application screens, suitable for implementing the context-aware virtual assistant system, in accordance with some examples.

FIG. 5 illustrates side-by-side screens where a first screen shows certain annotations, in accordance with some examples.

FIG. 6 illustrates side-by-side screens having certain annotations, in accordance with some examples.

FIG. 7 illustrates a screenshot of a screen displaying certain annotations, in accordance with some examples.

FIG. 8 illustrates side-by-side screens having certain annotations and dynamic GUI elements, in accordance with some examples.

FIG. 9 illustrates a derivation of a multi-modal model output, according to some examples.

FIG. 10 illustrates a machine learning engine suitable for training the one or more LLMs, in accordance with some examples.

FIG. 11 is a block diagram depicting a machine suitable for executing instructions via one or more processors, in accordance with some examples.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as automating the delivery of domain-specific advice and help across an organization to a very large set of users in a more uniform manner. In certain examples, context-aware virtual assistant techniques are described, that improve user interactions with virtual assistants in variety of applications, including financial applications. A context-aware virtual assistant system enables users to interact directly with the data displayed on their screens using various annotation techniques, such as drawings, text, and/or audio. The context-aware virtual assistant system interprets user annotations (such as handwritten notes, drawings, and/or audio) directly on the mobile device's screen. In some examples, one or more artificial intelligence (AI) models, such as large language models (LLMs), are used to analyze the annotations and to derive a desired user action based on the annotations and contextual information. Contextual information includes a screen or screen portion related to the annotation, text “pointed” to by the annotation, and so on. By allowing users to annotate directly on a screen, the context-aware virtual assistant system provides for a more intuitive and direct way for users to communicate. Accordingly, the techniques described herein reduce overhead time used in typing or providing more verbose descriptions to a virtual assistant, and result in more efficient interactions with the virtual assistant.

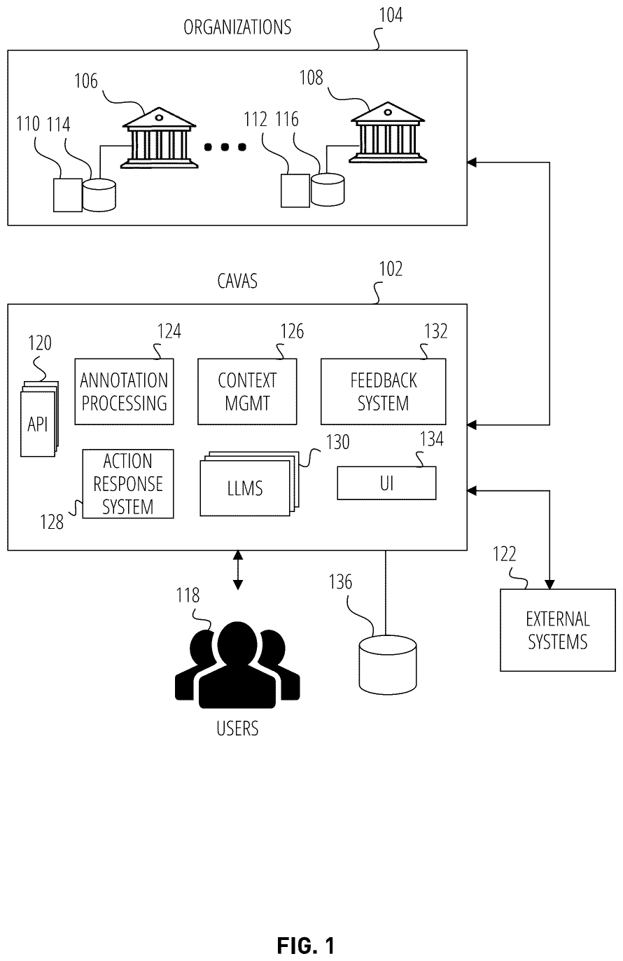

Turning now to FIG. 1, the figure is a block diagram depicting a context-aware virtual assistant system (CAVAS) 102, in accordance with certain examples. In some examples, the CAVAS 102 is provided by certain organizations 104, such as financial organizations 106, business organizations 108, service provider organizations, and so on. The CAVAS 102 provides for online assistance, interactive conversations, and/or personalized recommendations, thus aiding employees or customers of the organizations 104 to better perform their job duties and to more easily navigate and use the organizations 104. Further, the CAVAS 102 handles multiple conversations, such as online conversations, simultaneously, allowing organizations to scale their customer support or internal assistance by simply adding information technology (IT) resources. The CAVAS 102 additionally delivers more consistent responses to inquiries, thus enabling employee and/or customers to receive the same level of service regardless of the agent they interact with. In a non-limiting example when the CAVAS 102 is used in a banking domain, the CAVAS 102 provides assistance such as transferring funds, answering questions related to account debits/credits, aiding in disputing charges, providing financial advice, scheduling appointments with banking personnel, and so on.

The financial organizations 106 include entities such as banks, investment companies, credit unions, insurance companies, and the like. The business organizations 108 include small businesses, medium-sized businesses, large businesses, franchises, online marketplaces, and so on. Other organizations 104 include federal, state, county, city, and/or municipal entities that pass laws and/or regulations for their respective jurisdictions, law enforcement agencies, government agencies, and so on. The organizations 104 include information systems 110, 112, that are communicatively coupled to data stores 114, 116, respectively. The information systems 110, 112 include online platforms, such as websites, web-based platforms, e-commerce platforms, social media platforms, customer support platforms, internal organization platforms (e.g., human resource systems, marketing and sales systems, product planning systems, IT systems) and so on, that provide for a variety of services and products to users 118.

The data stores 114, 116 include relational databases, filesystems, network databases, and so on, suitable for storing data acquired, produced and/or updated by the organizations 104. In use, the CAVAS 102 retrieves and/or saves data to the data stores 114, 116, for example, while providing for online assistance, interactive conversations, and/or personalized recommendations to the users 118. The CAVAS 102 includes an application programming interface (API) 120 suitable for programmatic operation of the CAVAS 102. For example, the API 120 enables external systems 122, such as mobile applications, websites, server software, application software, and the like, to interface with and use various subsystems included in the CAVAS 102, such as an annotation processing system 124, a context management system 126, an action response system 128, one or more large language models (LLMs) 130, a feedback system 132, a user interface (UI) system 134, and/or a data store 136. Accordingly, the API 120 includes a set of objects (e.g., classes, functions, callable code, and the like) suitable for programmatic operations of all the subsystems included in the CAVAS 102.

The annotation processing system 124 processes one or more annotations provided by the users 118. For example, the annotation processing system 124 detects and interprets user gestures used to activate or control features (e.g., a three-finger tap to start annotation mode), and enables the users 118 to make annotations directly on the screen. The annotations could include drawings, writing, typed text, or other forms of markup, as well as voice annotations. The context management system 126 derives a current context for each of the annotations entered by the users 118. For example, the current context includes a screen where the annotation has been entered, a portion of the annotated screen, information presented on the annotated screen and/or a screen portion, as further described below. The action response system 128 applies the user annotations and respective context to derive one or more actions the execute. For example, a user 118 navigates to a mobile banking application screen showing various credit card charges, and the user 118 then draws a circle around a charge and then additionally writes “dispute”.” The CAVAS 102 will derive the context (e.g., mobile banking application transaction screen) via the context management system 126, and the annotations (e.g., circle with “dispute” wording) via the annotation processing system 124. The action response system 128 will then execute a “dispute” action or actions based on the context (e.g., credit charge) that was annotated (e.g., circled with the “dispute” wording). Likewise, other banking example actions include locking a credit card, asking questions related to charges and/or accounts, and in general, assisting users that have annotated certain screen and/or screen portions.

In certain examples, the LLMs 130 are used to analyze user inputs, whether drawn, typed, or spoken, to determine the user's intent. This helps the CAVAS 102 understand what the user wants to achieve, such as disputing a transaction or asking about account details. In scenarios where users annotate directly on their screen, the LLMs 130 can integrate the textual and visual information to provide a comprehensive response. For example, if a user 118 circles a transaction and writes “Why this charge?”, the LLMs 130 can process both the image of the circled transaction and the handwritten query based on the screen's context to provide a specific explanation.

Additionally, the LLMs 130 learn from each interaction, adapting to user 118 preferences and improving over time. This learning capability allows the CAVAS 102 to become more efficient and personalized in handling requests. In some examples, user 118 feedback is analyzed by the feedback system 132 to refine and adjust the LLMs' responses, enhancing accuracy and user satisfaction. For example, the feedback system 132 after each interaction, is able to prompt the users 118 to rate their satisfaction with the response or the overall experience. The feedback system 132 also infers feedback from user behavior. For example, if a user 118 repeatedly rephrases a question or abandons the interaction, it might indicate dissatisfaction or confusion. Feedback data, especially identified issues or errors, is used to retrain the LLMs 130. This process involves adjusting the LLMs 130 to better understand and respond to similar queries in the future. The CAVAS 102 adapts dynamically by adjusting response strategies or interaction flows based on recent feedback. For instance, if users 118 frequently ask for clarification on a particular type of response, the CAVAS 102 learns to provide more detailed information initially.

The UI 134 provides for a graphical user interface that includes windows, icons, menus, buttons, and all the other elements that are manipulated by the user with a pointing device like a mouse or touchpad. The UI 134 also provides for touch interfaces designed for touch screens. These touch interfaces allow users to interact with the CAVAS 102 through touch gestures such as tapping, swiping, pinching, drawing, and/or writing. Voice User Interfaces (VUIs) are also included in the UI 134. The VUIs enable interaction with the CAVAS 102 through voice or speech commands.

The UI 134, in some examples, includes an overlay layer on top of a screen. The overlay layer can be activated through specific gestures, such as a three-finger tap or using a stylus. This layer then overlays the current screen content without obstructing visibility. Once activated, users can annotate (e.g, draw, type, and so on), or highlight directly on their screen. This enables the interaction with the data displayed, such as circling a transaction for queries or marking a text for more details. In some examples, the application presenting the screen does not use an overlay layer and instead, redraws the screen to include user annotations.

The data store 136 is used to store CAVAS data, such as data associated with annotation processing system 124, the context management system 126, the action response system 128, instructions for the LLMs 130, and/or the UI 134. For example, CAVAS can store the LLMs 130 training data (e.g., neural network data), natural language processing data, and the like. Similarly, annotations captured, contexts derived, user feedback received, and so on, can be stored and retrieved via the data store 136.

A practical application of the CAVAS 102 can be found in the context of an enhanced virtual assistant being provided by an organization 104, such as a financial institution, a business, a governmental body, and so on. The CAVAS 102 can be used to streamline the organization's automated assistance processes by providing timely information to various stakeholders, such as customers and employees within the organization. In a banking example, a bank customer is now able to manage transactions, dispute charges, and receive personalized financial advice directly through a mobile banking app without navigating through multiple menus or speaking to a human representative. In summary, the CAVAS 102 reduces the time users spend navigating software and waiting for customer service, leading to a more efficient user experience. The CAVAS 102 additionally increases user engagement by providing a more interactive and responsive interface, making virtual assistants more accessible, especially for users who may find traditional navigation more challenging. It is to understood that while the practical application is described in terms of a banking application, similar applications exist in other areas, such as but not restricted to manufacturing, insurance, software development, logistics, and so on.

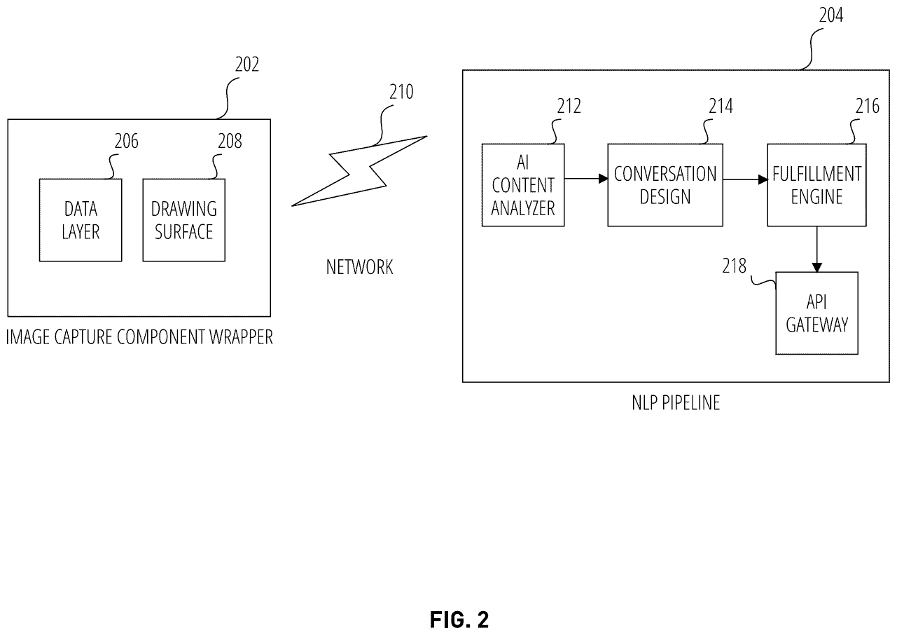

FIG. 2 is a block diagram of an image capture component wrapper 202 communicatively coupled to a natural language processing (NLP) pipeline 204, in accordance with certain examples. In the depicted example, the image capture component wrapper 202 is included in a client device, such as a mobile device, a notebook, a tablet, a personal computer, and so on. The image capture component wrapper 202 captures any annotations, gestures, or interactions made by the user on the client device's display. This includes drawings, text annotations, or other forms of input directly on the screen. The image capture component wrapper 202 includes a data layer 206 suitable for interfacing with one or more data stores, such as data stores 114, 116, 136. The data layer 206 is used to store and/or retrieve user inputs received, such as drawings, writings, voice input, and/or typed text. The data layer 206 is also used to store and/or retrieve context-related data, such as screen(s) used for an annotation, portions of a screen used for an annotation, transactions presented on a screen, transaction types, accounts presented on a screen, account types, and so on.

A drawing surface component 208, such as a transparent (e.g., invisible) or translucent (e.g., with some opacity) screen layer, works in conjunction with a physical surface used to receive user input. When the user 118 makes annotations on this physical surface, the drawing surface component 208 captures these interactions as image data. This drawing surface component 208 allows the user to interact with the displayed content without altering the actual content underlying the annotations, thus capturing the annotations as an overlay. Once the annotation inputs are captured, the image capture component wrapper 202 preprocesses this data. This preprocessing involves converting the annotation inputs into a format suitable for further analysis, such as enhancing the image quality, segmenting the image to focus on areas of interest, isolating the annotated parts from the rest of the display, and/or applying OCR to images.

After preprocessing, the captured and processed data is sent to the NLP Pipeline 204, for example, via a network 210. The network 210 includes WiFi networks, wired networks, local area networks (LANs), wide area networks (WANs), and the like, suitable to provide communications between the image capture component wrapper 202 and the NLP Pipeline 204. That is, the image capture component wrapper 202 is included in a client device that is communicatively coupled to a server device that executes the NLP Pipeline 204 via the network 210.

The AI content analyzer 212 includes various machine learning models, including multi-modal deep learning networks that are trained on large datasets relevant to the application's domain, such as the LLMs 130. In use, the AI content analyzer 212 determines the user's intent behind the input. For example, the AI content analyzer 212 determines whether the user is asking a natural language question, making a command, expressing a concern, and so on. In certain examples, the AI content analyzer 212 analyzes the text within the context (screen, screen portion, transaction ID, and so on) of the user's current interaction with the system. This analysis involves understanding the relevance of the input in relation to the displayed content or the user's historical interactions. Further, the AI content analyzer 212 performs named entity recognition (NER) to identify and to classify information in the text into predefined categories such as names, organizations, locations, dates, accounts, and other specific data pertinent to the application's domain. The AI content analyzer 212 additionally applies entity linking by mapping the recognized entities to relevant data sources or databases, thus enabling the system to fetch additional information or perform specific actions related to these entities. In some embodiments, the AI content analyzer 212 also performs sentiment analysis, thus analyzing the emotional tone behind the user's text to gauge sentiments such as satisfaction, frustration, or neutrality. This is particularly useful in customer service applications to tailor responses based on user sentiment.

The conversation design component 214 is adaptable to a range of applications, from customer service bots and virtual personal assistants to more complex applications like medical advisory systems or financial advising bots. In each case, the conversation design is tailored to meet the specific needs of the domain, ensuring that the conversational system can handle domain-specific queries, terminology, and user expectations more effectively. The conversation design component 214 maintains the current state of the conversation to understand the context of each user interaction. This includes tracking previous interactions, user preferences, and any relevant session data. The conversation design component 214 additionally manages the flow of the conversation, determining when to ask for more information, when to offer options, or when to execute a command based on the user's input and the conversation history. In some examples, the conversation design component 214 uses advanced language models, such as the LLMs 130, to generate more coherent and contextually appropriate responses. This can involve completing user queries, suggesting information, or constructing entire sentences to communicate with the user.

The fulfillment engine 216 is responsible for carrying out the actions determined by the AI content analyzer 212 and the conversation design component 214. Essentially, once the NLP Pipeline 204 understands what the user wants (intent recognition) and formulates an appropriate response (conversation design), the fulfillment engine 216 takes over to execute the actions used to fulfill the user's request. Accordingly, the fulfillment engine 216 uses an API gateway 218 to make calls to external APIs to retrieve data or interact with other systems. For example, fetching user account details from a database, processing a transaction, or integrating with third-party services. In some examples, the API gateway 218 includes the API 120. By providing for a client-server architecture via the image capture component wrapper 202 and the NLP Pipeline 204, the techniques described herein enable a more efficient and scalable context-aware virtual assistant system, such as the CAVAS 102.

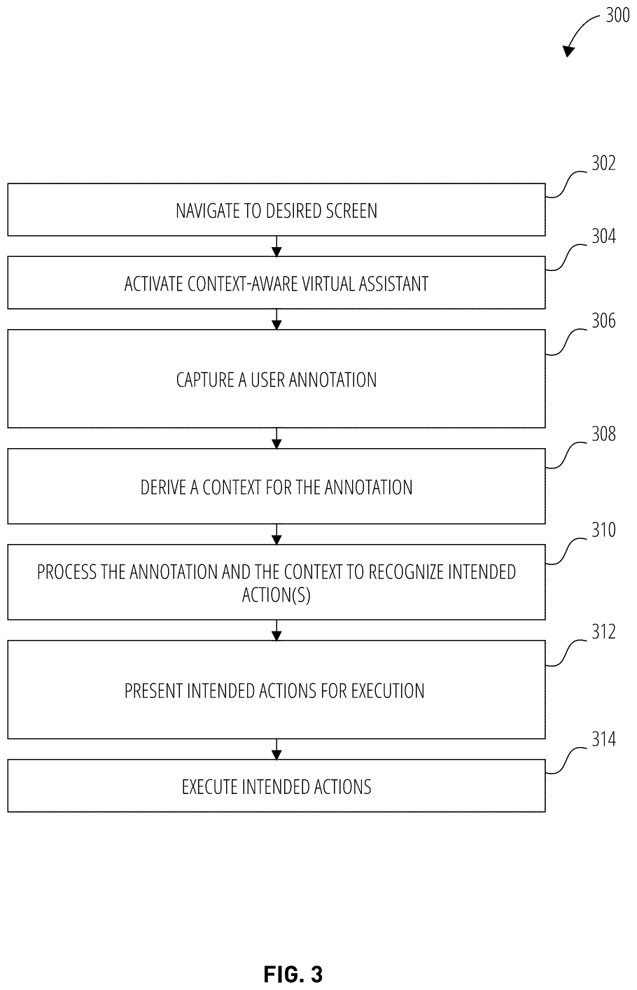

FIG. 3 is a flowchart of a process 300 suitable for using the CAVAS 102 to capture and to contextually process multi-model annotations, in accordance with certain examples. The process 300 is used, for example, to implement the CAVAS 102, thus resulting in a practical application of the techniques described herein.

In the depicted example, the process 300 navigates, at block 302, to a desired screen of a software application, such as a mobile application, a website, and so on. For example, a graphical user interface, such as the UI 134, is used to navigate to the desired screen. In a non-limiting banking application example, a user 118 logs in and then proceeds to a screen of interest, such as a screen listing credit card transactions, a screen listing accounts, a screen for payments and transfers, and so on. The process 300 then activates, at block 304, a context-aware virtual assistant system, such as the CAVAS 102. The context-aware virtual assistant system is activated by pressing a control, such as a button, a menu item, an icon, and the like, by using gesture control, such as double tapping, pinching, swiping, and/or by using voice control, such as by voicing “enable virtual assistant.” It is to be noted that, in some examples, the context-aware virtual assistant system is always activated.

The process 300 then captures, at block 306, one or more annotations. Annotations include drawings (e.g., circles, arrows, underlines, and so on) that are overlaid on top of certain information displayed on the screen. For example, a transaction screen displays various transactions ordered by date, and an annotation includes a circle drawn around a transaction, an arrow pointing to a transaction, and so on. The annotations also include written text, such as “dispute,” “lock,” “more information,” and the like. Voice annotations include capturing the user saying, “dispute transaction number 150”, “lock my credit card”, “give me details on transaction 22”, and so on. Annotations further include typed text. It is to be noted that annotations can be combined, thus resulting in hybrid annotations. For example, a circled transaction can be combined with a voice annotation saying, “dispute this.”

The process 300 then derives, at block 308, a context for the annotation. The context includes information relevant to the annotation that was previously captured. For example, if the user drew a circle around a transaction (e.g., a subset of information presented in a screen that includes many transactions), the context then includes the transaction data such as the transaction ID, the date, the amount, the payee, the account used for the transaction, and so on. The context also includes other information related to the annotation, such as the name of the screen used to capture the annotation, a date and a time that the annotation was entered by the user, any previous annotations (e.g., other annotations previously captured in the same user session on the same or on different screens), and so on.

The process 300 then recognizes, at block 310, intended actions based on the captured annotation(s) and the derived context. For example, optical character recognition (OCR) and image processing algorithms are used to identify and interpret textual content or graphical elements involved in the annotation. For instance, if a user circles a word or a set of numbers, the CAVAS 102 recognizes these elements as focal points of the query. Likewise, an arrow pointing to certain information, and/or underlining of certain information Using the LLMs 130, the system analyzes any textual annotations to extract user intent. This involves parsing the language to understand commands or queries (e.g., “Why this charge?” or “Compare prices”). In some example, sentiment analysis might be employed to gauge the user's emotional tone, such as when writing “Why this charge???? ” In some examples, the process 300 can process the annotation (e.g, textual annotation, drawing annotation, spoken annotation) to create a data store query based on the annotation and on the context. For example, LLM techniques can be used to convert the annotation and the context into a SQL query that queries a data store and returns a result. A virtual assistant can then assist the user with the result. For example, an LLM model included in the virtual assistant can engage the user in conversation (e.g., question/answer session) to assist the user in getting further information based on the result.

Based on the recognized intended action, the process 300 presents, at block 312, one or more actions for execution. For example, the UI 134, is used to present a menu of actions on the screen for the user to activate, such as a menu having options for disputing a charge, for getting additional information on a charge, for finding similar charges, and the like. In some examples, the UI 134 provides a summary description of the action along with prompts to proceed or to cancel, such as via a dialog box asking “Would you like to proceed with locking your credit card? Yes/No.” The process 300 then executes, at block 314, an action selected by the user. For example, a credit card can be locked, a transaction disputed, similar transactions can be searched for, and so on. That is, commands such as a transaction dispute command, a placing a credit card lock command, a placing a debit card lock command, and/or a scheduling a customer representative command, and so on, can be automatically executed. It is to be noted that based on the domain of the CAVAS 102, e.g., financial domain, business domain, governmental agency domain, and so on, the actions presented will vary.

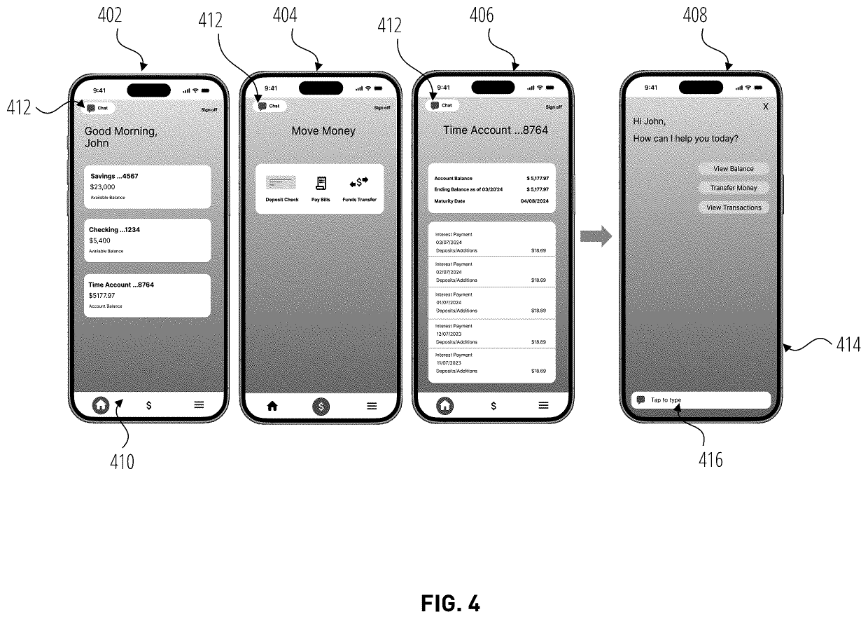

FIG. 4 illustrates screenshots of various screens, such as mobile banking application screens, suitable for implementing the context-aware virtual assistant system, in accordance with some examples. In the depicted embodiment, the example screens include an accounts screen 402, a payment and transfer screen 404, an account balance and transactions screen 406, and a virtual assistant screen 408. The accounts screen 402 is used to provide for banking account information, such as cash account information, credit account information, loan account information, and so on. In some examples, the accounts screen 402 is a “home” screen of the application, and provides for a GUI section 410 suitable for navigating to other screens, such as the screens 404, 406, 408.

The payment and transfer screen 404 is used to pay certain bills as well as to transfer money to internal accounts (e.g., accounts in the same bank) and external entities or external accounts. The account balance and transactions screen 406 presents more detailed information on a user account (e.g., cash account information, credit account information, loan account information) as well as transactions recorded for the account.

Screens 402, 404, 406 also include a GUI section 412 that is used to interface with, for example, a virtual assistant. In the depicted example, activating the GUI section 412 then brings up the virtual assistant screen 408. The virtual assistant screen 408 includes GUI sections 414, 416 that can then be used to ask questions, chat, and more generally, interface with the virtual assistant. The techniques described herein provide for context-aware virtual assistant systems that can provide assistance via annotations on the screens 402, 404, and/or 406, as described in more detail below.

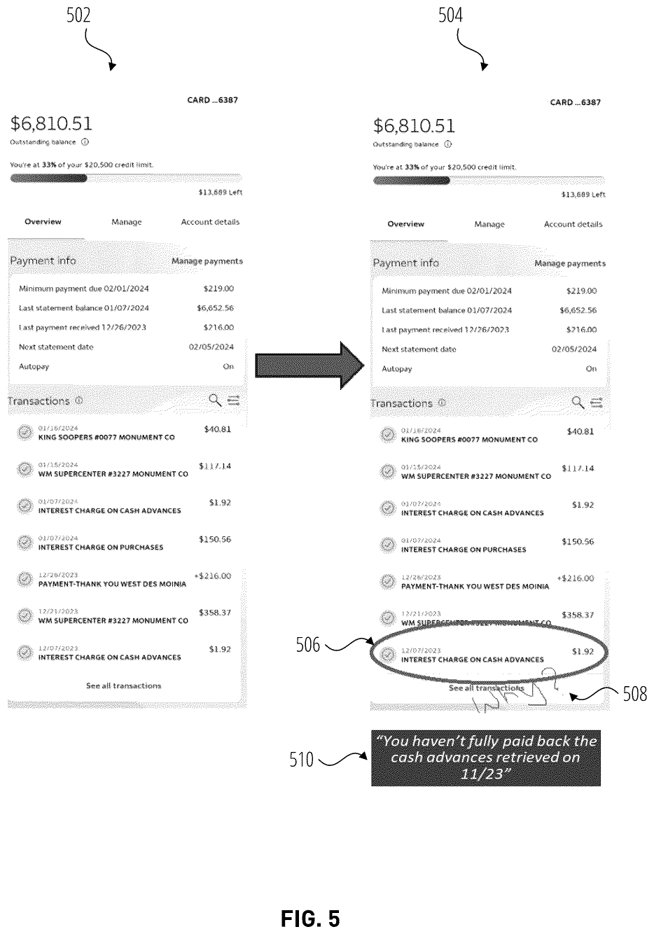

FIG. 5 illustrates side-by-side screens 502, 504 where screen 504 shows certain annotations, in accordance with some examples. More specifically, screen 504 is screen 502 but with multi-modal annotations 506 and 508 added by a user 118. In the depicted embodiment, the user 118 has first drawn a shape (e.g., circle) as annotation 506 overlaid on an interest charge transaction. The user then manually wrote “why?” as annotation 508. More specifically, a touchscreen is used, that receives stylus and/or finger touch input. Accordingly, a user can enter handwriting as the annotation 508 via stylus input and/or finger touch input. Likewise, the user can draw a shape such as the shape 506 as part of the annotation. In the depicted example, the shape 506 encloses a transaction (e.g., interest charge on a credit card) as part of the context. That is, the shape 506 encloses a subset of the presented textual information in the rest of the screen 504. In some examples, the shape 506 can also be an arrow shape pointing to the subset of the presented textual information and/or an underline that underlines the subset of the presented textual information.

The techniques describe herein enable the user 118 to annotate certain screens and/or screen portions, and the CAVAS 102 will then derive a desired intended action. For example, the annotations 506, 508, are interpreted against the context (e.g., transaction inside of the circle annotation 506) to determine that the user 118 is asking the reason for an interest charge transaction. Accordingly, the CAVAS 102 provides a response 510, such as “You haven't fully paid back the cash advances retrieved on 11/23.” By providing for a context-aware virtual assistant system, such as the CAVAS 102, the techniques described herein enable a more efficient and user-friendly interaction with virtual assistants.

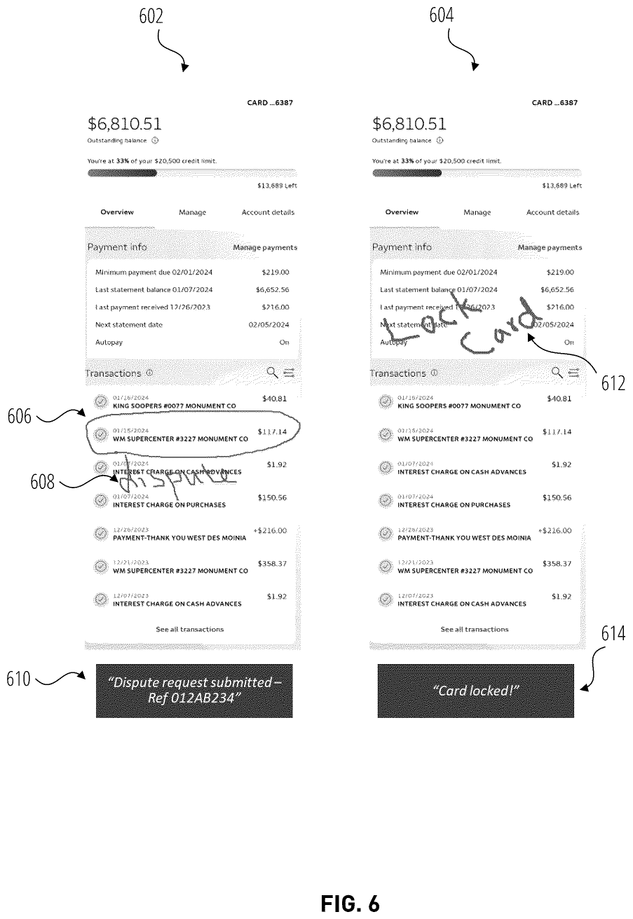

FIG. 6 illustrates side-by-side screens 602, 604 having certain annotations, in accordance with some examples. In the depicted example, screen 602 includes annotations 606, 608. Annotation 606 is a circular shape overlaid around a charge transaction while annotation 608 is a written annotation of the word “dispute.” The CAVAS 102 will derive that the circled transaction is being disputed by the user 118, and will then provide a response 610, such as “Dispute request submitted-Ref 012AB234” representative of a dispute action. That is, the CAVAS 102 will dispute the desired transaction and then respond.

Screen 604 includes a single written annotation 612. The written annotation 612 states “Lock card” and is superimposed over a payment information portion of the screen 604. In this example, the CAVAS 102 will derive that the user 118 would like to lock the credit card whose transactions are shown via the screen 604. Accordingly, the CAVAS 102 will then execute a lock action on the credit card account associated with the screen 604 and then provide a response 614, stating that the card is now locked.

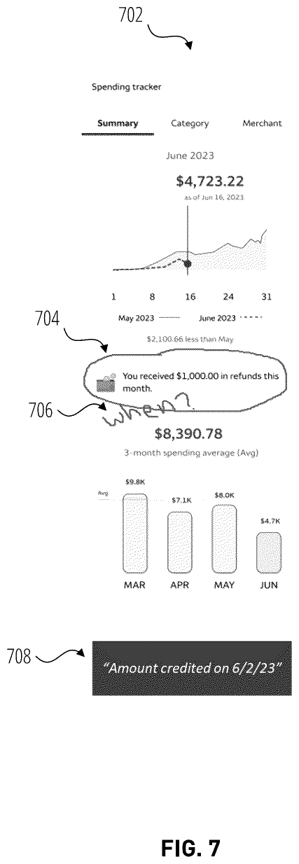

FIG. 7 illustrates a screenshot of a screen displaying certain annotations, in accordance with some examples. In the depicted example the screen 702 is a spending tracker screen used to track expenditures. Annotations 704 and 706 are shown. Annotation 704 is a circle shape overlaid around a refund transaction, while annotation 706 is a writing annotation asking “when?” In this example, the CAVAS 102 will derive that the user 118 would like to know a date of when the refund transaction occurred. Accordingly, the CAVAS 102 will execute a date lookup action on the circled transaction and provide a response 708 with the lookup date. In the depicted example, the response 708 states “Amount credited on Jun. 2, 2023.” By enabling quick annotations on various screen sections, the techniques described herein provide for a more intuitive and efficient manner for querying information and for requesting a variety of actions to be performed.

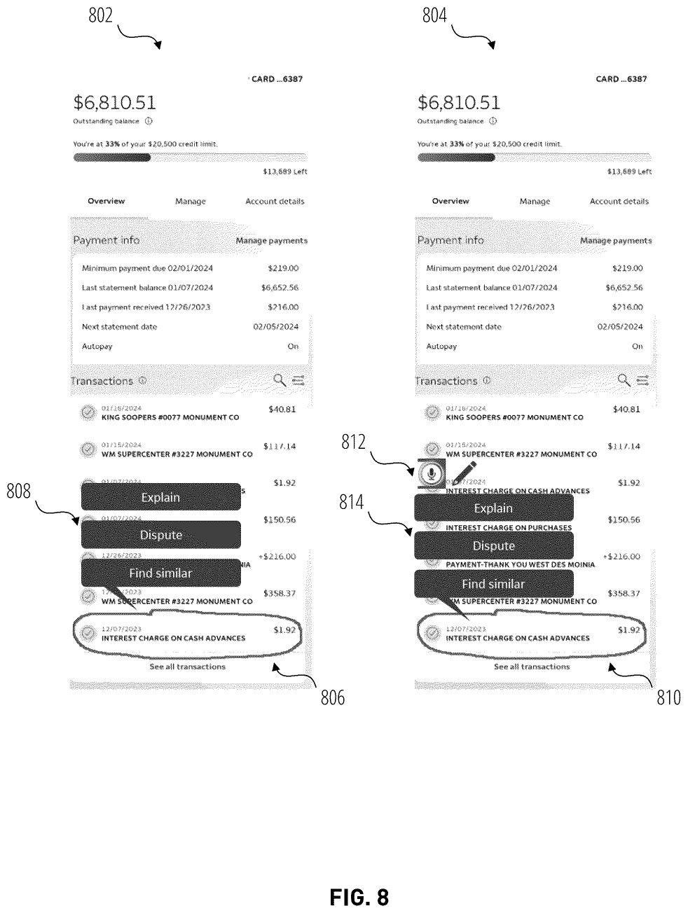

FIG. 8 illustrates side-by-side screens 802, 804 having certain annotations and dynamic GUI elements, in accordance with some examples. In the depicted example, the screen 802 shows an annotation 806. More specifically, the annotation 806 is a circular shape overlaid over an interest charge transaction. In this example, the user 118 has enable an automatic presentation of actions mode that triggers certain dynamic GUI elements, such as a menu list 808. Once the user has annotated a screen section, the automatic presentation of actions mode then automatically derives actions related to the annotation. In some examples, if there are more than a certain number of actions that may be taken based on the annotation, the CAVAS 102 will narrow down the menu list 808 to present the top actions usually requested by the users 118. In the depicted example, there are three actions typically taken by the users 118 when annotating interest charge transactions. Accordingly, the menu list 808 presents three action items, “Explain,” “Dispute,” and “Find similar.” Indeed, the CAVAS 102 can present customized actions based on information types annotated, such as different transaction types. The user 118 can then activate one of the presented action items, for example, by clicking on the action item. The CAVAS 102 will then execute the activated action item.

Screen 804 is the same as screen 802 and includes an annotation 810 that is the same as annotation 806, but additionally has a voice preference mode turned on. When the voice preference mode is turned on, a GUI element 812, such as a microphone icon, is displayed. The user 118 then talks to the CAVAS 102, for example, to ask questions. In some examples, the CAVAS 102 will then respond back via voice. In the depicted example, the automatic presentation of actions mode is also enabled. Accordingly, the CAVAS 102 displays a menu list 814 which is the same as the menu list 808 because the same interest charge transaction is being annotated. It is to be noted that the automated presentation of actions mode and the voice preference mode can be used together or individually. When voice preference mode is used individually, the menu list 814 is not displayed. By providing for hybrid modes of annotation and/or responses, the techniques described herein provide for improved customization so that the user 118 is more productive.

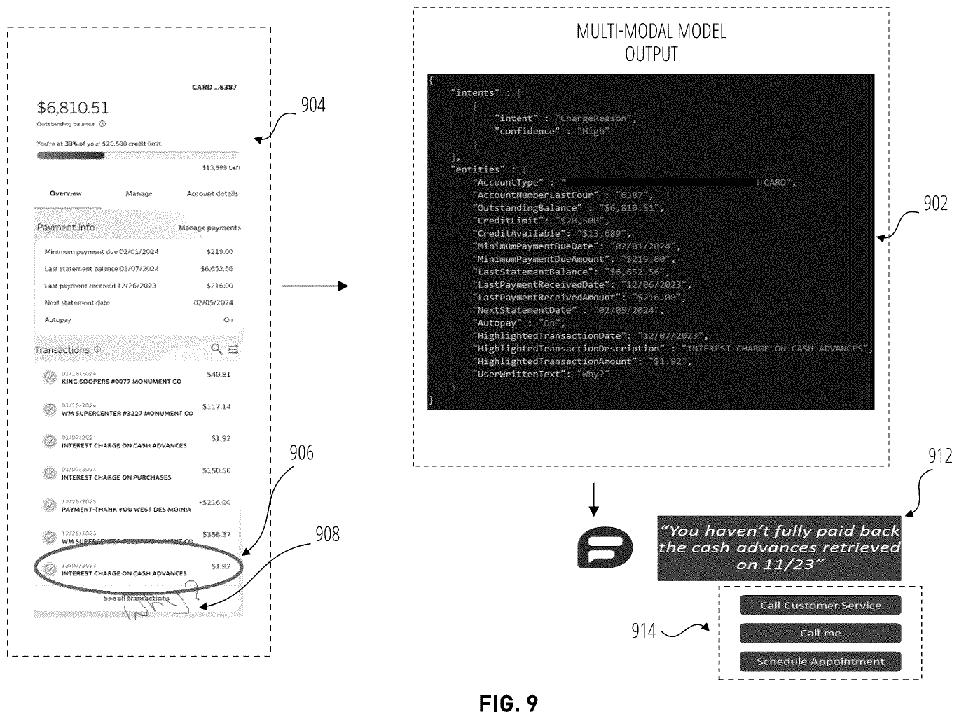

FIG. 9 illustrates a derivation of a multi-modal model output 902, according to some examples. In the depicted example, a screen 904 first presents certain information to the user 118, such as payment information and transactions. The user 118 then creates annotations 906, 908, suitable for asking for certain information. More specifically, annotation 906 is a circle shape overlaid on top of an interest charge transaction, while annotation 908 is a writing annotation asking “why?” As mentioned earlier, the CAVAS 102 will then derive, based on the annotations 906, 908 and context information (e.g., the interest charge transaction) that the intended action is to ask for the reason that the interest charge was accrued. More specifically, the CAVAS 102 outputs the multi-modal model output 902, for example, via the NLP Pipeline 204. In the depicted embodiment, the multi-modal model output 902 includes an “intents” section suitable for storing one or more derived intended actions, and an “entities” section suitable for storing context information (e.g., transaction information), annotation information (e.g., text that was written), and related information (e.g., account information of the account impacted by the interest charge). In some examples, the multi-modal model output 902 is derived via the LLMs 130. That is, the LLMs 130 apply generative AI to generate the

The CAVAS 102 then uses the multi-modal model output 902 to derive a response 912. That is, the CAVAS 102 will then perform the intended action included in the multi-modal model output 902 to query the data stores for additional information and then generate the response 912, stating that “You haven't fully paid back the cash advances retrieved on 11/23.” In some examples, the CAVAS 102 will also present a GUI list 914 (e.g., list of commands) associated with the response 912. In the depicted example, the GUI list 914 enables the user to more easily follow up with their original question by calling customer service, asking for a call back, or scheduling an appointment. By providing for contextual awareness of annotations via a virtual assistant, the techniques described herein provide for targeted responses while increasing user efficiency.

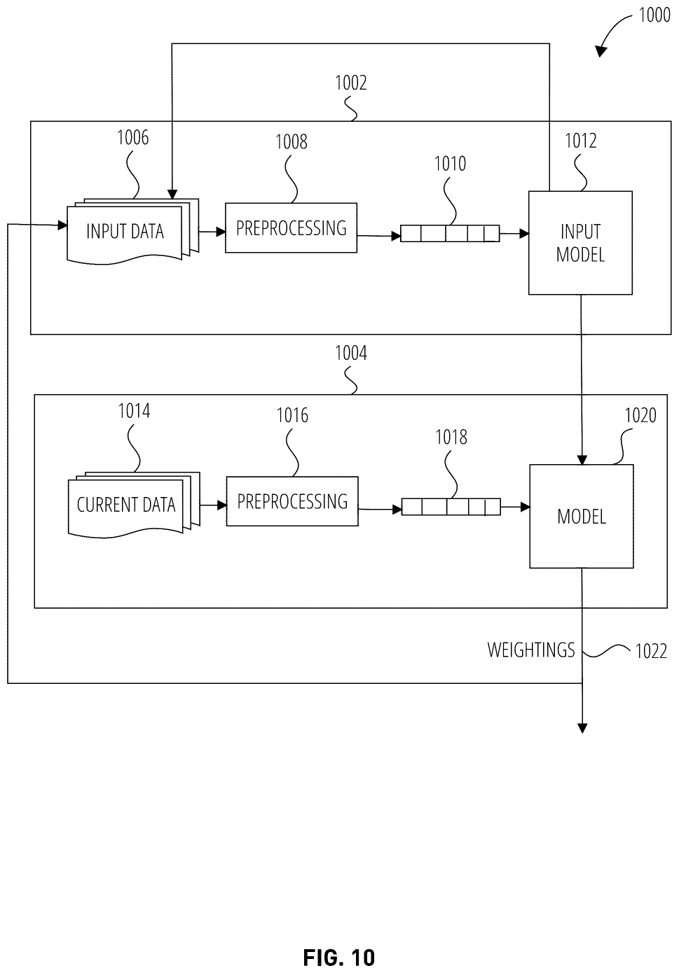

FIG. 10 illustrates a machine learning engine 1000 suitable for training the one or more LLMs 130 of the CAVAS 102, in accordance with some examples. The machine learning engine 1000 may be deployed to execute at a mobile device (e.g., a cell phone), a computer, a server, a cloud-based system, and so on. In some examples, a system, such as the CAVAS 102, may calculate one or more weightings for criteria based upon one or more machine learning algorithms via the machine learning engine 1000, used in training the LLMs 130 of FIG. 1.

In the depicted example, the machine learning engine 1000 uses a training engine 1002 and a prediction engine 1004. The training engine 1002 uses input data 1006, for example after undergoing preprocessing via the preprocessing component 1008, to determine one or more features 1010. The one or more features 1010 may be used to generate an initial input model 1012, which may be updated iteratively or with future labeled or unlabeled data (e.g., during reinforcement learning or fine tuning).

For the LLMs 130, the input data 1006 includes a large corpus of subject matter material, including general and specific process knowledge of the organizations 104. In some examples, open source training data sets such as C4, common crawl, and/or wikipedia are used as the input data 1006. Fine tune training includes using detailed knowledge of an organization that will be using the CAVAS 102. The detailed knowledge includes organizational structure, organizational functions, organization's responsibilities, organization's duties, organization's mission, department descriptions, department functions, department responsibilities, department duties, employee job description, employee responsibilities, employee duties, organizational charts, organizational procedures and processes, department procedures and processes, customer service procedure and processes employee procedures and processes, and other forms of organizational knowledge.

In the prediction engine 1004, current data 1014 may be input to preprocessing component 1016. In some examples, preprocessing component 1016 and preprocessing component 1008 are the same. The prediction engine 1004 produces feature vector 1018 from the preprocessed current data, which is input into the model 1020 to generate one or more criteria weightings 1022. The criteria weightings 1022 may be used to output a prediction, as discussed further below.

The training engine 1002 may operate in an offline manner to train the model 1020 (e.g., on a server). The prediction engine 1004 may be designed to operate in an online manner (e.g., in real-time, at a mobile device, on a wearable device, etc.). In some examples, the model 1020 may be periodically updated via additional training (e.g., via updated input data 1006 or based on labeled or unlabeled data output in the weightings 1022) or based on identified future data, such as by using reinforcement learning to personalize a general model (e.g., the initial model 1012) to a particular user and/or organization. Labels for the input data 1006 may include organizational labeling of certain knowledge, including anonymous labeling, e.g., “employee A.”

The initial model 1012 may be updated using further input data 1006 until a satisfactory model 1020 is generated. The model 1020 generation may be stopped according to a specified criteria (e.g., after sufficient input data is used, such as 1000,000, 1 million, 2 billion data points, etc.) or when data converges (e.g., similar inputs produce similar outputs).

The specific machine learning algorithm used for the training engine 1002 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 1002. In an example embodiment, a regression model is used and the model 1020 is a vector of coefficients corresponding to a learned importance for each of the features in the vector of features 1010, 1018. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like. Once trained, the model 1020 may now correspond to the trained LLMs 130.

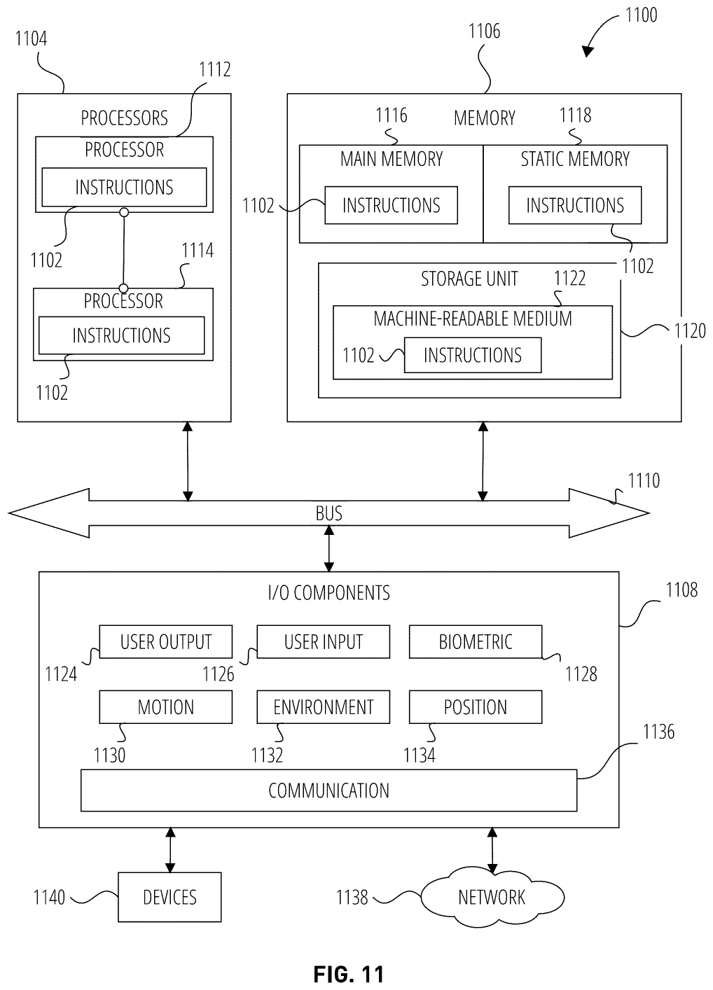

FIG. 11 is a diagrammatic representation of a machine 1100 within which instructions 1102 (e.g., software, a program, an application, an applet, an app, or other executable code stored in a non-transitory computer-readable medium) for causing the machine 1100 to perform any one or more of the methodologies discussed herein may be executed. For example, the instructions 1102 may cause the machine 1100 to execute any one or more of the processes or methods described herein, such as the process 200. The instructions 1102 transform the general, non-programmed machine 1100 into a particular machine 1100, e.g., the CAVAS 102, programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. In some examples, the machine 1100 may also comprise both client and server systems, with certain operations of a particular method or algorithm being performed on the server-side and with certain operations of the particular method or algorithm being performed on the client-side.

The machine 1100 may include processors 1104, memory 1106, and input/output I/O components 1108, which may be configured to communicate with each other via a bus 1110. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 1112 and a processor 1114 that execute the instructions 1102. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1116, a static memory 1118, and a storage unit 1120, both accessible to the processors 1104 via the bus 1110. The main memory 1116, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1130 include acceleration sensor components (e.g., accelerometer), gravitation sensor components, rotation sensor components (e.g., gyroscope).

The environmental components 1132 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1134 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1108 further include communication components 1136 operable to couple the machine 1200 to a network 1138 or devices 1140 via respective coupling or connections. For example, the communication components 1136 may include a network interface component or another suitable device to interface with the network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a universal serial bus (USB) port), internet-of-things (IoT) devices, and the like.

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

The techniques described herein provides a generative AI approach to policy alerting, policy drafting, and policy management, offering organizations a proactive, intelligent, and customizable solution for navigating the complexities of policy changes. By leveraging the capabilities of a Large Language Model (LLM), the system continuously monitors one or more databases for changes to policy records, retrieves these changes, and utilizes the LLM to analyze the implications of these changes on various entities within the organization. The LLM identifies which entities are affected by the policy changes. It does so by processing the changes as input and deriving a potential impact for each affected entity. The system is designed to identify entities whose potential impact exceeds a customizable threshold, ensuring that only the most pertinent changes are flagged for further attention. Once the system identifies the affected entities, it generates an impact assessment report for each one. This report is not a mere notification but a comprehensive analysis that outlines the implications of the policy changes, providing actionable insights for the recipients. The LLM's sophisticated understanding of language and context allows it to produce reports that are tailored to the specific needs and functions of each entity, thereby enhancing the relevance and utility of the information provided.

What is claimed is:

1. A method, comprising:
presenting, via a graphical user interface (GUI), a GUI screen on a display of a computing device, wherein the GUI screen is configured to present textual information;
capturing an annotation made by a user on a portion of the GUI screen, wherein the annotation comprises a textual annotation, a drawing annotation, or a combination thereof;
deriving a context for the annotation based at least on the portion of the GUI screen having the annotation, wherein the context comprises a subset of the presented textual information;
creating a data store query based on the context and on the annotation;
querying, via the data store query, a data store; and
presenting, via the GUI, a result based on the querying of the data store.

2. The method of claim 1, wherein the capturing the annotation further comprises presenting a GUI layer overlaid on top of the GUI screen and displaying the annotation in the GUI layer.

3. The method of claim 2, wherein the GUI layer comprises a transparent layer or a translucent layer.

4. The method of claim 1, wherein capturing the annotation comprises deriving a natural language question based on the annotation, and wherein creating the data store query comprises creating the data store query based on the natural language question.

5. The method of claim 4, wherein the natural language question comprises a question based on a transaction included in the context, based on a financial charge included in the context, based on when the transaction occurred, or a combination thereof.

6. The method of claim 1, further comprising initiating a command based on the annotation.

7. The method of claim 6, wherein the command comprises a transaction dispute command, placing a credit card lock command, placing a debit card lock command, scheduling a customer representative command, or a combination thereof.

8. The method of claim 1, wherein the display comprises a touchscreen configured to receive a stylus input, a finger touch input, or a combination thereof.

9. The method of claim 8, wherein the textual annotation comprises a handwriting entered via the stylus input, the finger touch input, or a combination thereof.

10. The method of claim 9, comprising deriving, via optical character recognition (OCR), a text based on the handwriting, and wherein creating the data store query further comprises creating the data store query based on the context and on the text.

11. The method of claim 10, wherein the creating the data store query further comprises using a large language model (LLM) that receives the text as input to determine if the text includes a natural language question.

12. The method of claim 1, wherein the drawing annotation comprises a shape used to derive the context for the annotation.

13. The method of claim 12, wherein the shape encloses the subset of the presented textual information.

14. The method of claim 12, wherein the shape points to the subset of the presented textual information.

15. The method of claim 1, further comprising presenting a virtual assistant to assist a user with the result.

16. The method of claim 1, wherein the annotation comprises a spoken annotation, and wherein deriving the context for the annotation comprises converting the spoken annotation into text, and wherein creating the data store query comprises creating the data store query based on the context and on the text.

17. The method of claim 1, further comprising presenting, via the GUI, a list of commands based on the result.

18. A non-transitory computer-readable medium storing instructions that, when executed by one or more processors of a computer system, cause the computer system to perform operations comprising:
presenting, via a graphical user interface (GUI), a GUI screen on a display of a computing device, wherein the GUI screen is configured to present textual information;
capturing an annotation made by a user on a portion of the GUI screen, wherein the annotation comprises a textual annotation, a drawing annotation, or a combination thereof;
deriving a context for the annotation based at least on the portion of the GUI screen having the annotation, wherein the context comprises a subset of the presented textual information;
creating a data store query based on the context and on the annotation;
querying, via the data store query, a data store; and
presenting, via the GUI, a result based on the querying of the data store.

19. A virtual assistant system, comprising:
a memory; and
a processor configured to execute instructions, wherein the instructions are configured to:
present, via a graphical user interface (GUI), a GUI screen on a display of a computing device, wherein the GUI screen is configured to present textual information;
capture an annotation made by a user on a portion of the GUI screen, wherein the annotation comprises a textual annotation, a drawing annotation, or a combination thereof;
derive a context for the annotation based at least on the portion of the GUI screen having the annotation, wherein the context comprises a subset of the presented textual information;
create a data store query based on the context and on the annotation;
query, via the data store query, a data store; and
present, via the GUI, a result based on the querying of the data store.

20. The virtual assistant system of claim 19, wherein the instructions are further configured to assist a user, via a large language model (LLM), by engaging with the user in a question/answer session based on the result.
